(19) United States
(12) Patent Application Publication
(10) Pub. No.: US 2018/0123359 A1
(43) Pub. Date: May 3, 2018

(54) POWER SUPPLY APPARATUS AND CHARGE-DISCHARGE CONTROL METHOD

(71) Applicant: FUJITSU LIMITED, Kawasaki-shi (JP)

(72) Inventor: Shinya Miyata, Kawasaki (JP)

(73) Assignee: FUJITSU LIMITED, Kawasaki-shi (JP)

(21) Appl. No.: 15/708,200

(22) Filed: Sep. 19, 2017

(30) Foreign Application Priority Data
Nov. 2, 2016 (JP) 2016-215606

(51) Int. Cl. H02J 7/00

(52) U.S. Cl. CPC H02J 7/0021; H02J 7/345; H02J 7/007

(57) ABSTRACT

LICs are grouped into a plurality of LIC groups. Switches switch a power-feed path to allow charging and discharging to be performed for a combination of the LIC groups. A life diagnostic unit obtains the lives of the LICs. A charge-discharge priority controller sets a priority of each of the LIC groups based on the lives of the respective LICs. A charge-discharge managing unit selects one or more of the LIC groups for which charging and discharging are performed, based on the priority set by the charge-discharge priority controller and supplied power demanded during discharging, and controls the switches to allow charging and discharging to be performed for a combination of the selected one or more of the LIC groups.

### CROSS-REFERENCE TO RELATED APPLICATION

This application is based upon and claims the benefit of priority of the prior Japanese Patent Application No. 2016-215606, filed on Nov. 2, 2016, the entire contents of which are incorporated herein by reference.

### FIELD

The embodiment discussed herein is related to a power supply apparatus and a charge-discharge control method.

### BACKGROUND

In recent years, a power storage device such as a lithium ion capacitor (LIC) has been attracting attention as a power storage device for a mobile electronic device such as a mobile phone, a smartphone, and a laptop personal computer.

A power supply apparatus using such a power storage device uses an LIC-mounted module that includes a plurality of assembled batteries connected in series where, in each of the assembled batteries, a plurality of power storage devices are connected in parallel. For example, there is an LIC-mounted module in which three assembled batteries each including two power storage devices connected in parallel are connected in series, that is, the LIC-mounted module includes two rows of three power storage devices connected in series.

There is a conventional technique of a power supply apparatus in which a switch is provided for switching the connection between cells in a power storage device including a plurality of power storage cells to achieve series connection or parallel connection in accordance with the statuses of the power storage cells. There is another conventional technique in which a switch is provided for periodically switching the connection between capacitors in a backup power supply including a plurality of lithium capacitors to achieve series connection or parallel connection. There is still another conventional technique in which a switch is provided for performing switching in such a manner that a plurality of cells in a battery pack can be charged and discharged in units of parallel connection, and a cell to be charged and discharged is switched at a regular time interval. There is still another conventional technique in which a switch is provided in such a manner that a plurality of cells in a battery pack can be charged and discharged in units of parallel connection, and an arbitrary cell can be charged and discharged.

However, because the LIC-mounted module in which lithium ion capacitors are connected to one another is managed as one block, if the life of any one of the mounted lithium capacitors has expired, it is needed to replace the entire LIC-mounted module with a new one. Further, because the lithium ion capacitors are repeatedly charged and discharged all at once, the lives of all the lithium ion capacitors have expired at around the same time. In this manner, the life of lithium ion capacitors mounted on the LIC-mounted capacitor may become shorter.

Further, even if the conventional technique of switching series connection and parallel connection in accordance with the statuses of the power storage cells is used, there is a possibility that the life of any one of the lithium ion capacitors becomes shorter, and it is difficult to make the life of the LIC-mounted module longer. Furthermore, even if the conventional technique of periodically switching series connection and parallel connection is used, it is also difficult to make the life of the LIC-mounted module longer. Further, even if the conventional technique of switching the cell to be charged and discharged at a regular time interval is used, in a case where rapid degradation of the life in a specific lithium ion capacitor occurs, it is difficult to average the lives of the LICs in the LIC-mounted module, and is also difficult to make the life of the LIC-mounted module longer. Furthermore, even if the conventional technique of allowing charging and discharging to be performed for an arbitrary power storage cell is used, the statuses of the power storage cells are not monitored, and there is a possibility that the life of any one of the lithium ion capacitor becomes shorter, and therefore it is difficult to make the life of the LIC-mounted module longer.

### SUMMARY

According to an aspect of an embodiment, a power supply apparatus includes: a plurality of power storage devices that are grouped into a plurality of sets; a switching unit that switches a power-feed path to allow charging and discharging to be performed for a combination of the sets; a life diagnostic unit that obtains lives of the power storage devices; a priority setting unit that sets a priority of each of the sets based on the lives of the respective power storage devices; and a charge-discharge managing unit that selects one or more of the sets for which charging and discharging are performed, based on the priority set by the priority setting unit and supplied power demanded during discharging, and that controls the switching unit to allow charging and discharging to be performed for a combination of selected one or more of the sets.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a power supply apparatus;

FIG. 2 is a diagram of an example of a switch switching table;

FIG. 3 is a diagram illustrating an example of use statuses of LICs;

FIG. 4 is a flowchart of charge-discharge control for an LIC by the power supply apparatus according to an embodiment;

FIG. 5 is a flowchart of an example of a life diagnostic process;

FIG. 6 is a flowchart of an example of a priority determining process;

FIG. 7 is a flowchart of an example of a switch switching control process;

FIG. 8 is a flowchart of an example of a charge control process; and

FIG. 9 is a flowchart of an example of a discharge control process.

### DESCRIPTION OF EMBODIMENT

Preferred embodiments of the present invention will be explained with reference to accompanying drawings. The power supply apparatus and the charge-discharge control method disclosed in the present application are not limited to the following embodiments.

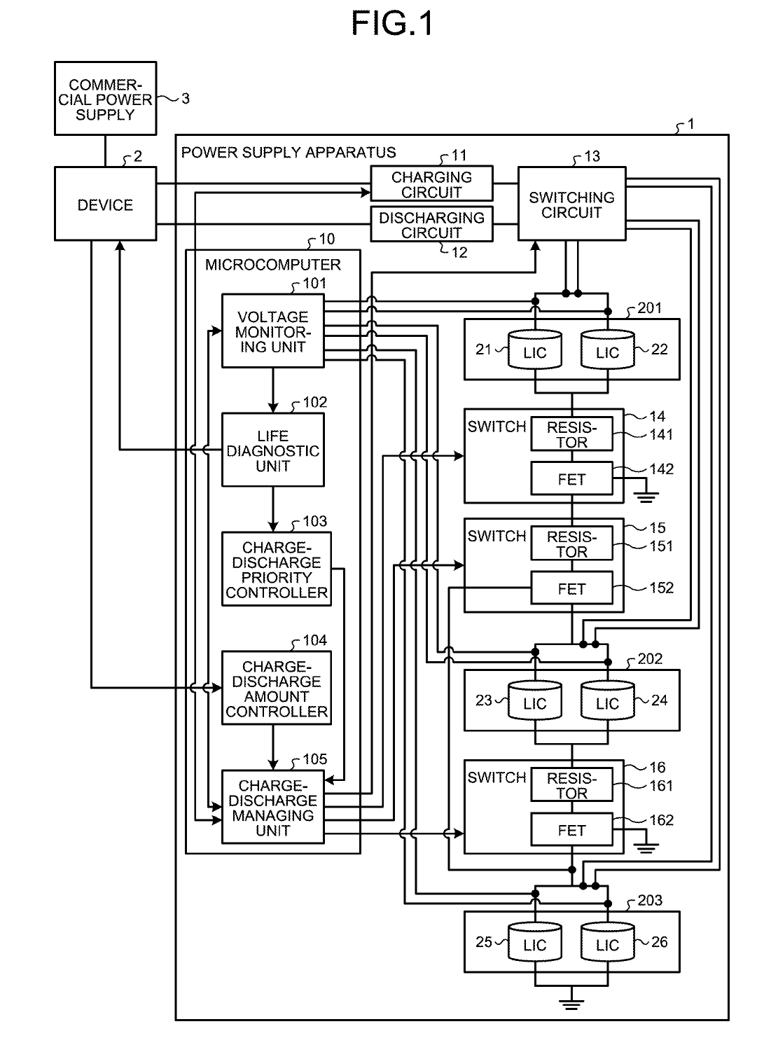

FIG. 1 is a block diagram of a power supply apparatus. A solid line in FIG. 1 represents a path of power supply. Solid arrows in FIG. 1 represent input and output of a signal.

A power supply apparatus 1 supplies power to a device 2. The device 2 is a device that is operated by using the power supplied thereto, and is a server or a storage, for example. The device 2 is connected to a commercial power supply 3. For example, when there is power supply from the commercial power supply 3 to the device 2, the device 2 is operated by using the power supplied from the commercial power supply 3. The device 2 also supplies a portion of the power supplied from the commercial power supply 3 to the power supply apparatus 1 in order to charge the power supply apparatus 1. When the power supply from the commercial power supply 3 is stopped due to power outage or the like, the device 2 is operated by using the power supplied from the power supply apparatus 1.

The power supply apparatus 1 according to an embodiment includes a microcomputer 10, a charging circuit 11, a discharging circuit 12, a switching circuit 13, switches 14 to 16, and LICs (lithium ion capacitors) 21 to 26.

The charging circuit 11 receives power supply from the device 2 during charging. The charging circuit 11 then outputs the supplied power to the switching circuit 13. When the charging is completed, the charging circuit 11 receives an input of a notification of charging completion from a charge-discharge managing unit 105. The charging circuit 11 then finishes receiving the power supply from the device 2.

The discharging circuit 12 receives an input of power from the switching circuit 13 in a case of performing power supply to the device 2. The discharging circuit 12 then supplies the input power to the device 2.

The switching circuit 13 receives power supply from the charging circuit 11 during charging. The switching circuit 13 also receives an instruction, from the charge-discharge managing unit 105, indicating any of the LICs 21 and 22, the LICs 23 and 24, and LICs 25 and 26 as destinations of the power supply. The switching circuit 13 then supplies the power supplied from the charging circuit 11 to the specified supply destination.

The LICs 21 to 26 are power storage devices. The LICs 21 and 22 are connected in parallel to configure one assembled battery. The LICs 23 and 24 are connected in parallel to configure one assembled battery. The LICs 25 and 26 are connected in parallel to configure one assembled battery. The LICs 21 to 26 form one LIC-mounted module. Further, the LICs 21 to 26 can be replaced in units of assembled batteries formed by LICs connected in parallel. The LICs 21 to 26 are an example of “power storage device”.

The LICs 21 and 22 are connected to the LICs 23 and 24 in series when the switch 14 is connected to the switch 15 and the switch 15 is connected to the LICs 23 and 24. Also, the LICs 21 and 22 are connected to the LICs 25 and 26 in series when the switch 14 is connected to the switch 15 and the switch 15 is connected to the LICs 25 and 26. In a state where the switch 14 is connected to the ground, a power supply path is terminated at the LICs 21 and 22.

The LICs 23 and 24 are connected to the LICs 21 and 22 in series when the switch 14 is connected to the switch 15 and the switch 15 is connected to the LICs 23 and 24. Also, the LICs 23 and 24 are connected to the LICs 25 and 26 in series when the switch 16 is connected to the LICs 25 and 26. In a state where the switch 16 is connected to the ground, the power supply path is terminated at the LICs 23 and 24.

The LICs 25 and 26 are connected to the LICs 21 and 22 in series when the switch 14 is connected to the switch 15 and the switch 15 is connected to the LICs 25 and 26. Also, the LICs 25 and 26 are connected to the LICs 23 and 24 in series when the switch 16 is connected to the LICs 25 and 26. The LICs 25 and 26 are connected to the ground, and the power supply path is terminated there irrespective of the statuses of the switches 14 to 16.

The LICs 21 to 26 are an LIC-mounted module having two rows of three LICs connected in series at maximum. The LICs 21 to 26 are an LIC-mounted module having two rows of one LIC at minimum. During charging, an LIC among the LICs 21 to 26, to which the switching circuit 13 is directly connected, is an inlet of power supply from the switching circuit 13. An LIC connected in series to the LIC among the LICs 21 to 26, which serves as the inlet, is charged by the supplied power. When there is no series connection with the LIC as an inlet, only the LIC among the LICs 21 to 26 serving as the inlet of power supply is charged.

Further, during discharging, an LIC among the LICs 21 to 26, to which the switching circuit 13 is directly connected, is an outlet of power supply to the switching circuit 13. An LIC connected in series to the LIC among the LICs 21 to 26 serving as the outlet performs discharging. When there is no series connection with the LIC as an outlet, only the LIC among the LICs 21 to 26 serving as the outlet of power supply performs discharging.

The switch 14 includes a resistor 141 and an FET (Field Effect Transistor) 142. The switch 14 performs switching whether to connect a power-feed path extending from the LICs 21 and 22 to the ground or to the switch 15, in response to control from the charge-discharge managing unit 105.

The switch 15 includes a resistor 151 and an FET 152. The switch 15 performs switching whether to connect a power-feed path extending from the switch 14 to the LICs 23 and 24 or to the LICs 25 and 26, in response to control from the charge-discharge managing unit 105.

The switch 16 includes a resistor 161 and an FET 162. The switch 16 performs switching whether to connect a power-feed path extending from the LICs 23 and 24 to the ground or to the LICs 25 and 26, in response to control from the charge-discharge managing unit 105.

The microcomputer 10 includes a voltage monitoring unit 101, a life diagnostic unit 102, a charge-discharge priority controller 103, a charge-discharge amount controller 104, and the charge-discharge managing unit 105. Each unit of the microcomputer 10 stores therein in advance a fact that a combination of LICs connected in parallel among the LICs 21 to 26 is handled as one group. In the present embodiment, each unit of the microcomputer 10 handles the LICs 21 and 22 as an LIC group 201, the LICs 23 and 24 as an LIC group 202, and the LICs 25 and 26 as an LIC group 203. These LIC groups 201 to 203 are an example of “set”.

The voltage monitoring unit 101 monitors voltages of the respective LICs 21 to 26. The voltage monitoring unit 101 then outputs information on the measured voltages of the respective LICs 21 to 26 to the charge-discharge managing unit 105. The voltage monitoring unit 101 also outputs the information on the measured voltages of the respective LICs 21 to 26 to the life diagnostic unit 102 when a life diagnostic process is performed.

When the life diagnostic process is performed, the life diagnostic unit 102 receives an input of the information on the voltages of the respective LICs 21 to 26 from the voltage monitoring unit 101. The life diagnostic unit 102 then acquires a voltage of each of the LICs 21 to 26 at the time of starting constant current discharging in the life diagnostic process.

Further, the life diagnostic unit 102 acquires a voltage of each of the LICs 21 to 26 at a regular time interval from the start of discharging. The life diagnostic unit 102 then performs extrapolation, to 0 second, for a straight line that is obtained from times at a regular time interval from the start of discharging and the voltage of each of the LICs 21 to 26 by the least squares method. Subsequently, the life diagnostic unit 102 calculates an internal resistance by using a voltage and a discharge current at 0 second. The discharging current is 1 ampere, for example.

Further, the life diagnostic unit 102 stops discharging after the discharging is performed for a predetermined time, and thereafter acquires a voltage of each of the LICs 21 to 26 at a time when the voltage is in a steady state. The life diagnostic unit 102 then calculates an electrostatic capacitance by using the voltage of each of the LICs 21 to 26 at the start of discharging and the voltages of each of the LICs 21 to 26 acquired at a regular time interval. For example, the life diagnostic unit 102 calculates an internal resistance value by using an expression C=I×t/Vt−Vf, where C is an electrostatic capacitance, Vf is a voltage of each of the LICs 21 to 26 at the start of discharging, and Vt is a voltage of each of the LICs 21 to 26 in a steady state after a predetermined time has passed and discharging has been stopped.

Thereafter, the life diagnostic unit 102 compares the calculated internal resistance and electrostatic capacitance and predetermined thresholds for each of the LICs 21 to 26, thereby diagnosing the life of each of the LICs 21 to 26. If there is an LIC among the LICs 21 to 26 of which the life has expired, the life diagnostic unit 102 outputs an instruction, to the device 2, to replace LICs belonging to the LIC group to which the LIC of which the life has expired belongs with new LICs. Upon reception of the replacement instruction of LICs, a manager replaces the LICs belonging to the specified LIC group.

On the other hand, if there is no LIC among the LICs 21 to 26 of which the life has expired, the life diagnostic unit 102 obtains the life of each of the LIC groups 201 to 203 from the life of each of the LICs 21 to 26. For example, the life diagnostic unit 102 sets an average of the lives of the LICs 21 and 22 belonging to the LIC group 201 as the life of the LIC group 201. The life diagnostic unit 102 then outputs information on the obtained life of each of the LIC groups 201 to 203 to the charge-discharge priority controller 103.

In the present embodiment, the life diagnostic unit 102 uses the average of the lives of LICs among the LICs 21 to 26, which belong to each of the LIC groups 201 to 203, as the life of that LIC group. However, another value may be used as the life of each of the LIC groups 201 to 203. For example, it is possible that the life diagnostic unit 102 sets a shorter one of the lives of LICs among the LICs 21 to 26, which belong to each of the LIC groups 201 to 203, as the life of that LIC group. The life of each of the LIC groups 201 to 203 is an example of “group life”.

The charge-discharge priority controller 103 receives an input of information on the lives of the respective LIC groups 201 to 203 from the life diagnostic unit 102. The charge-discharge priority controller 103 then sets the priority of one of the LIC groups 201 to 203 that has the longest life as 1. Also, the charge-discharge priority controller 103 sets the priority of one of the LIC groups 201 to 203 that has the second longest life as 2. Further, the charge-discharge priority controller 103 sets the priority of one of the LIC groups 201 to 203 that has the shortest life as 3. In the present embodiment, the priority is lower as the number becomes larger. Thereafter, the charge-discharge priority controller 103 outputs the set priorities of the respective LIC groups 201 to 203 to the charge-discharge managing unit 105. The charge-discharge priority controller 103 is an example of “priority setting unit”.

The charge-discharge amount controller 104 receives from the device 2 an input of power consumption used by the device 2 when the device 2 is activated. The charge-discharge amount controller 104 then outputs the acquired power consumption of the device 2 to the charge-discharge managing unit 105. This power consumption is an example of “a supplied power demanded during discharging”.

Further, the charge-discharge amount controller 104 receives from the device 2 again an input of the power consumption used by the device 2 after discharging to the device 2. The charge-discharge amount controller 104 then outputs the acquired power consumption of the device 2 to the charge-discharge managing unit 105.

The charge-discharge managing unit 105 detects activation of the device 2 from the start of power supply to the charging circuit 11 from the device 2. The charge-discharge managing unit 105 then determines to perform the life diagnostic process at the time of activation of the device 2 and at a regular time interval after activation of the device 2. When the life diagnostic process is performed, the charge-discharge managing unit 105 notifies the voltage monitoring unit 101 of the start of the life diagnostic process. The charge-discharge managing unit 105 then switches the switch 14 to be connected to the switch 15. The charge-discharge managing unit 105 also switches the switch 15 to be connected to the LICs 23 and 24. The charge-discharge managing unit 105 also switches the switch 16 to be connected to the LICs 25 and 26. Further, the charge-discharge managing unit 105 instructs the switching circuit 13 to perform charging for life diagnosis by power supply to the LICs 21 and 22.

The charge-discharge managing unit 105 determines completion of charging to an LIC among the LICs 21 to 26, which is a charging target, based on information on the voltage of each of the LICs 21 to 26 input from the voltage monitoring unit 101. After completion of charging to the LIC among the LICs 21 to 26 in the life diagnostic process, the charge-discharge managing unit 105 instructs the switching circuit 13 to perform discharging for life diagnosis by discharging from the LICs 21 and 22.

After the life diagnostic process is ended, the charge-discharge managing unit 105 receives an input of the priorities of the respective LIC groups 201 to 203 from the charge-discharge priority controller 103. Further, the charge-discharge managing unit 105 receives an input of information on the power consumption of the device 2 from the charge-discharge amount controller 104.

Subsequently, the charge-discharge managing unit 105 assigns charging capacitances to the LIC groups 201 to 203 in descending order of priority to achieve the power consumption. In a case where the charging capacitance of one of the LIC groups 201 to 203 can cover the power consumption, the charge-discharge managing unit 105 determines to use only one of the LIC groups 201 to 203 that has the priority of 1. In a case where the charging capacitances of two of the LIC groups 201 to 203 can cover the power consumption, the charge-discharge managing unit 105 determines to use the groups among the LIC groups 201 to 203, which have the priorities of 1 and 2, respectively. Further, in a case of using all the LIC groups 201 to 203, the charge-discharge managing unit 105 determines to use all the LIC groups 201 to 203. In this manner, the charge-discharge managing unit 105 selects the minimum number of LICs among the LIC groups 201 to 203, for which the total of the charging capacitances is equal to or larger than the power consumption.

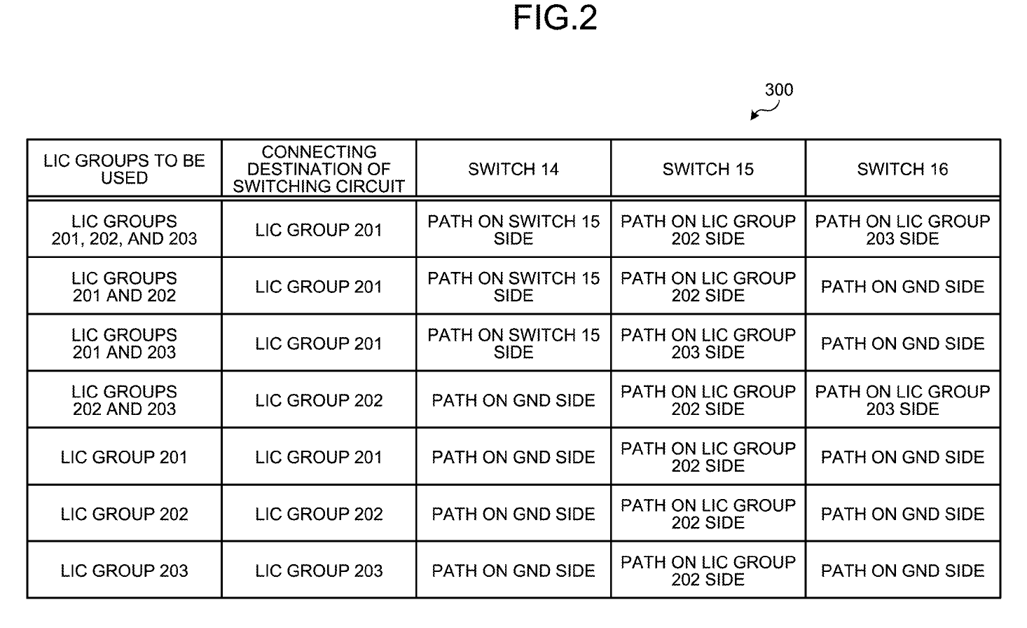

Subsequently, the charge-discharge managing unit 105 controls the switching circuit 13 and the switches 14 to 16 in such a manner that charging is performed for one or more groups among the LIC groups 201 to 203, which are determined to be used. In this example, the charge-discharge managing unit 105 has, for example, a switch switching table 300 illustrated in FIG. 2 in advance. FIG. 2 is a diagram of an example of a switch switching table. In this example, GND in FIG. 2 represents the ground. The charge-discharge managing unit 105 acquires switching destinations in accordance with the group that is determined to be used from the switch switching table 300, and controls the switching circuit 13 and the switches 14 to 16 in accordance with acquired information.

For example, in a case where it is determined to use the LIC groups 201 and 203, the charge-discharge managing unit 105 sets a connecting destination of the switching circuit 13 to the LIC group 201. Further, the charge-discharge managing unit 105 switches the switch 14 to be connected to the ground, switches the switch 15 to be connected to the LICs 25 and 26, and switches the switch 16 to be connected to the ground. The types of connection illustrated in FIG. 2 are only examples, and other types of connection can be employed as long as a path that enables charging for one or more groups among the LIC groups 201 to 203, which are determined to be used, to be performed is formed. For example, in a case of using any one of the LIC groups 201 to 203, all the switches 14 to 16 can be connected to the ground.

The charge-discharge managing unit 105 then determines whether a charging capacitance has reached the power consumption of the device 2, based on the information on the voltages of the respective LICs 21 to 26 input from the voltage monitoring unit 101. When the charging capacitance has reached the power consumption of the device 2, the charge-discharge managing unit 105 determines the charging has been completed. After completion of the charging, the charge-discharge managing unit 105 stands by until discharging to the device 2 is started.

When the charge-discharge managing unit 105 is standing by, the charge-discharge managing unit 105 determines whether charging is needed based on the information on the voltages of the respective LICs 21 to 26 input from the voltage monitoring unit 101. For example, the charge-discharge managing unit 105 determines to perform charging when the voltage of any of the LICs 21 to 26 falls below a predetermined threshold. When charging is performed, the charge-discharge managing unit 105 instructs the switching circuit 13 to perform charging, without changing connecting statuses of the switching circuit 13 and the switches 14 to 16. Thereafter, the charging-discharging management unit 105 causes the switching circuit 13 to perform charging until the charging capacitance reaches the power consumption of the device 2.

Further, when discharging to the device 2 is started, the charge-discharge managing unit 105 causes the switching circuit 13 to perform discharging until discharging to the device 2 is ended. After power supply from the commercial power supply 3 to the device 2 is recovered and discharging from the power supply apparatus 1 is ended, the charge-discharge managing unit 105 performs the life diagnostic process. Thereafter, the charge-discharge managing unit 105 determines one or more groups to be used, switches a path, performs charging, and stands by. In the present embodiment, although the charge-discharge managing unit 105 always performs the life diagnostic process after discharging, the charge-discharge managing unit 105 is not limited to this example. It is also possible to configure that the charge-discharge managing unit 105 performs charging again by using connection at this time without performing any life diagnosis.

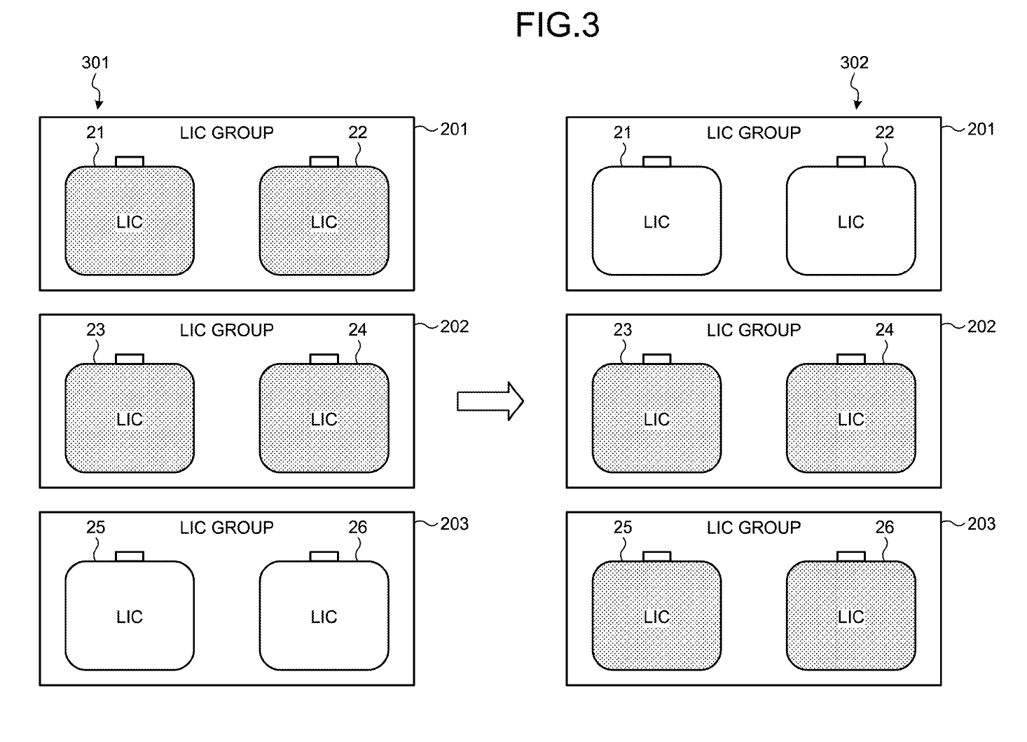

Next, an operation of an LIC in the power supply apparatus according to the present embodiment is described with reference to FIG. 3. FIG. 3 is a diagram illustrating an example of use statuses of LICs.

A status 301 represents an LIC-mounted module at a certain timing. A status 302 represents the LIC-mounted module after groups to be used are changed. In the statuses 301 and 302, LICs among the LICs 21 to 26, which are grayed out, are LICs for which charging and discharging are performed.

In the status 301, the LIC groups 201 and 202 are set to groups to be used. That is, in the status 301, charging and discharging are performed for the LICs 21 to 24.

When discharging occurs or a timing to perform life diagnosis comes in the status 301, power consumption of the device 2 is notified again, the life diagnosis is performed, and priorities are determined again by the charge-discharge priority controller 103. The priorities are assigned in descending order of the life. Thereafter, one or more groups to be used among the LIC groups 201 to 203 are determined by the charge-discharge managing unit 105.

In this case, as in the status 302, the LIC groups 202 and 203 are determined as the groups to be used. That is, in the status 302, charging and discharging are performed for the LICs 23, 24, 25, and 26.

In this manner, in the power supply apparatus 1 according to the present embodiment, the number of LICs to be used among the LICs 21 to 26 is changed in accordance with power consumption. Further, an LIC having a longer life is used preferentially. Because only an appropriate number of LICs among the LICs 21 to 26 are used, it is possible to suppress useless charging and discharging. Further, because the LIC having a longer life is preferentially used, the use statuses of the respective LICs 21 to 26 can be made uniform, so that degradation of a specific LIC can be lessened.

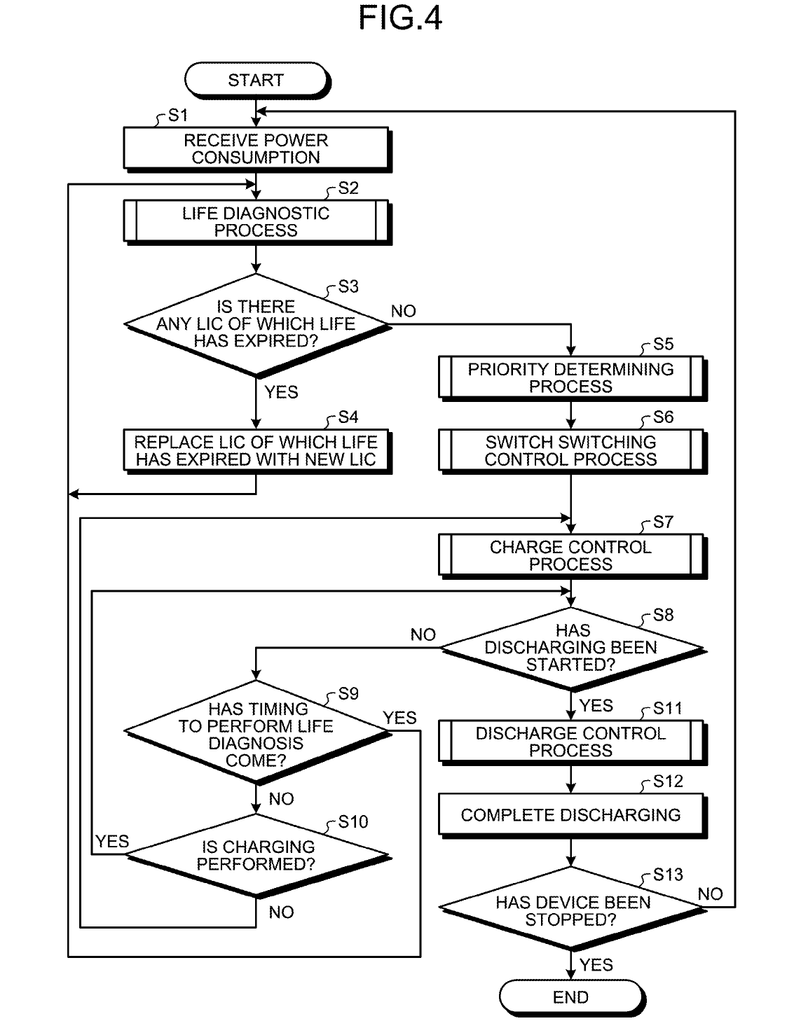

Next, a flow of charge-discharge control for the LICs 21 to 26 by the power supply apparatus 1 according to the present embodiment is described with reference to FIG. 4. FIG. 4 is a flowchart of charge-discharge control for an LIC by the power supply apparatus according to the present embodiment.

The charge-discharge amount controller 104 receives power consumption of the device 2 (Step S1). The charge-discharge amount controller 104 then outputs information on the power consumption of the device 2 to the charge-discharge managing unit 105.

The charge-discharge managing unit 105 switches the switches 14 to 16 in such a manner that the LICs 21 to 26 are connected to realize two rows of three serially connected LICs. The life diagnostic unit 102 and the charge-discharge managing unit 105 then perform a life diagnostic process of determining the lives of the respective LICs 21 to 26 (Step S2).

The life diagnostic unit 102 then determines whether there is any LIC among the LICs 21 to 26, of which the life has expired (Step S3). When there is an LIC among the LICs 21 to 26, of which the life has expired (YES at Step S3), the life diagnostic unit 102 transmits a notification of information on the LIC of which the life has expired to the device 2. A manager confirms the LIC of which the life has expired by using the device 2, and replaces the LIC of which the life has expired with a new one (Step S4). Thereafter, the process returns to Step S2.

On the other hand, when there is no LIC of which the life has expired (NO at Step S3), the life diagnostic unit 102 notifies the charge-discharge priority controller 103 of the lives of respective LIC groups 201 to 203. The charge-discharge priority controller 103 receives an input of the lives of the respective LIC groups 201 to 203 from the life diagnostic unit 102. The charge-discharge priority controller 103 then performs a priority determining process of determining priorities of the respective LIC groups 201 to 203 (Step S5).

Subsequently, the charge-discharge managing unit 105 receives an input of information on the power consumption of the device 2 from the charge-discharge amount controller 104. Further, the charge-discharge managing unit 105 receives an input of the priorities of the respective LIC groups 201 to 203 from the charge-discharge priority controller 103. The charge-discharge managing unit 105 then performs a switch switching control process of connecting a power-feed path to one or more LICs among the LICs 21 to 26, which are targets of charging and discharging (Step S6).

Next, the charge-discharge managing unit 105 performs a charge control process of charging one or more LICs among the LICs 21 to 26, which are the targets of charging and discharging (Step S7).

Thereafter, the charge-discharge managing unit 105 determines whether discharging to the device 2 has been started (Step S8). When discharging is not started (NO at Step S8), the charge-discharge managing unit 105 determines whether a timing to perform life diagnosis has come (Step S9). When the timing to perform the life diagnosis has come (YES at Step S9), the charge-discharge managing unit 105 returns to Step S2.

On the other hand, when the timing to perform the life diagnosis has not come (NO at Step S9), the charge-discharge managing unit 105 compares the voltage of each of the LICs 21 to 26 acquired from the voltage monitoring unit 101 and a threshold with each other, and determines whether to perform charging (Step S10).

When charging is performed (YES at Step S10), the charge-discharge managing unit 105 returns to Step S8. On the other hand, when charging is not performed (NO at Step S10), the charge-discharge managing unit 105 returns to Step S7 and stands by.

Meanwhile, when discharging has been started (YES at Step S10), the charge-discharge managing unit 105 performs a discharge control process of performing power supply from the power supply apparatus 1 to the device 2 (Step S11).

Thereafter, the charge-discharge managing unit 105 detects recovery of the power of the device 2, and completes discharging from the power supply apparatus 1 (Step S12).

Thereafter, the charge-discharge managing unit 105 determines whether the device 2 has been stopped (Step S13). When the operation of the device 2 continues (NO at Step S13), the process returns to Step S1. On the other hand, when the operation of the device 2 has been stopped (YES at Step S13), the charge-discharge managing unit 105 ends control of charging and discharging.

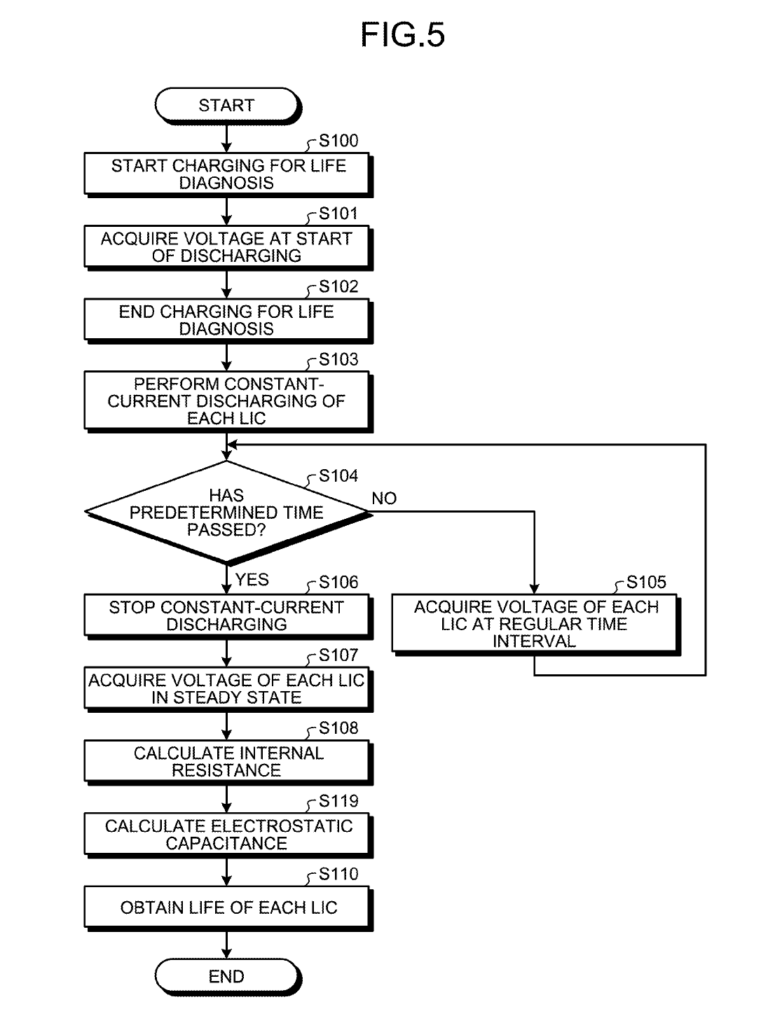

Next, a flow of a life diagnostic process is described with reference to FIG. 5. FIG. 5 is a flowchart of an example of the life diagnostic process. The flow illustrated in FIG. 5 is an example of the life diagnostic process performed at Step S2 in FIG. 4.

The charge-discharge managing unit 105 controls the switching circuit 13 to start charging and discharging for life diagnosis. The switching circuit 13 starts supply of power supplied from the charging circuit 11, to the LICs 21 and 22, and starts charging for life diagnosis (Step S100).

The life diagnostic unit 102 acquires voltages of LICs 21 to 26 at the start of discharging from the voltage monitoring unit 101 (Step S101).

The charge-discharge managing unit 105 detects completion of charging based on the voltages of the LICs 21 to 26 acquired from the voltage monitoring unit 101, and ends charging for life diagnosis by the switching circuit 13 (Step S102).

Next, the charge-discharge managing unit 105 causes the switching circuit 13 to perform constant-current discharging of each of the LICs 21 to 26 (Step S103).

The charge-discharge managing unit 105 determines whether a predetermined time has passed (Step S104). When the predetermined time has not passed (NO at Step S104), the life diagnostic unit 102 acquires a voltage of each of the LICs 21 to 26 from the voltage monitoring unit 101 at a regular time interval (Step S105).

On the other hand, when the predetermined time has passed (YES at Step S104), the life diagnostic unit 102 causes constant-current discharging by the switching circuit 13 to be stopped (Step S106).

When the voltages of the LICs 21 to 26 are in a steady state after constant-current discharging is stopped, the life diagnostic unit 102 acquires the voltages of the respective LICs 21 to 26 in a steady state (Step S107).

Subsequently, the life diagnostic unit 102 calculates an internal resistance of each of the LICs 21 to 26 based on the voltages acquired at a regular time interval (Step S108).

The life diagnostic unit 102 then calculates an electrostatic capacitance of each of the LICs 21 to 26 based on the voltage at the start of discharging and the voltage in a steady state (Step S109).

The life diagnostic unit 102 then obtains the life of each of the LICs 21 to 26 based on obtained internal resistance and electrostatic capacitance (Step S110).

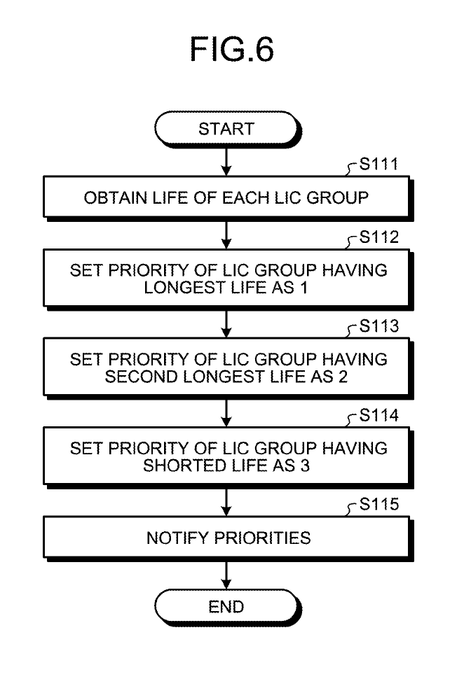

Next, a flow of a priority determining process is described with reference to FIG. 6. FIG. 6 is a flowchart of an example of the priority determining process. The flow illustrated in FIG. 6 is an example of the priority determining process performed at Step S5 in FIG. 4.

The life diagnostic unit 102 calculates the lives of the respective LIC groups 201 to 203 from the lives of the respective LICs 21 to 26. The life diagnostic unit 102 then outputs the lives of the respective LIC groups 201 to 203 to the charge-discharge priority controller 103. The charge-discharge priority controller 103 acquires the lives of the respective LIC groups 201 to 203 from the life diagnostic unit 102 (Step S111).

Next, the charge-discharge priority controller 103 sets the priority of one of the LIC groups 201 to 203 that has the longest life as 1 (Step S112).

The charge-discharge priority controller 103 then sets the priority of one of the LIC groups 201 to 203 that has the second longest life as 2 (Step S113).

The charge-discharge priority controller 103 then sets the priority of one of the LIC groups 201 to 203 that has the shortest life as 3 (Step S114).

Thereafter, the charge-discharge priority controller 103 notifies the charge-discharge managing unit 105 of the set priorities of the respective LIC groups 201 to 203 (Step S115).

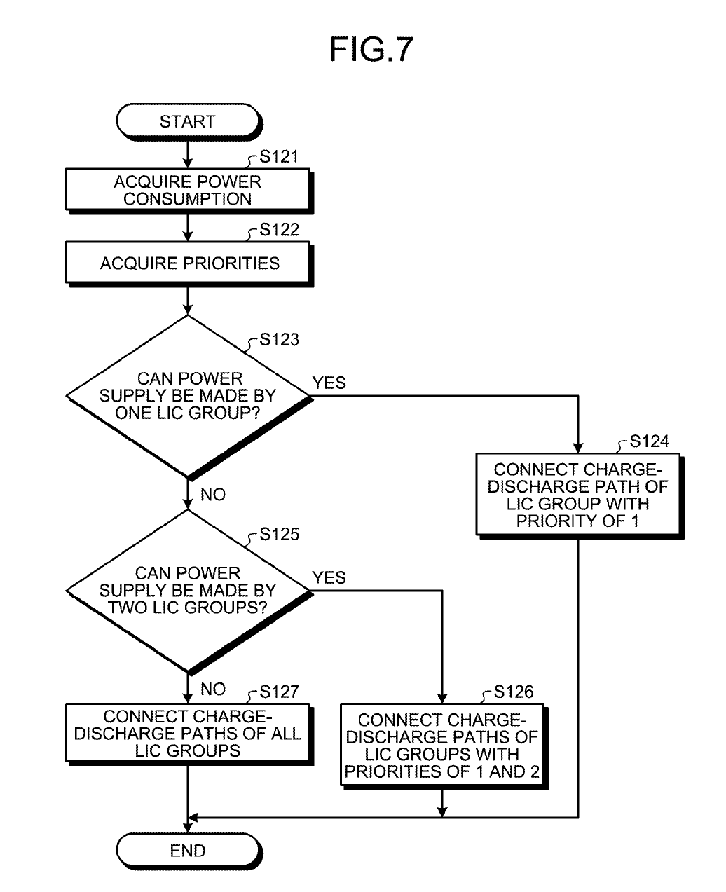

Next, a flow of a switch switching control process is described with reference to FIG. 7. FIG. 7 is a flowchart of an example of the switch switching control process. The flow illustrated in FIG. 7 is an example of the switch switching control process performed at Step S6 in FIG. 4.

The charge-discharge managing unit 105 acquires power consumption of the device 2 from the charge-discharge amount controller 104 (Step S121).

Next, the charge-discharge managing unit 105 acquires priorities of the respective LIC groups 201 to 203 from the charge-discharge priority controller 103 (Step S122).

Subsequently, the charge-discharge managing unit 105 determines whether power supply can be made by one of the LIC groups 201 to 203, based on the power consumption of the device 2 (Step S123).

Where power supply can be made by one of the LIC groups 201 to 203 (YES at Step S123), the charge-discharge managing unit 105 connects a charge-discharge path of one of the LIC groups 201 to 203 that has the priority of 1 (Step S124).

When it is difficult to make power supply by one of the LIC groups 201 to 203 (NO at Step S123), the charge-discharge managing unit 105 determines whether power supply can be made by two of the LIC groups 201 to 203 based the power consumption of the device 2 (Step S125).

When power supply can be made by two of the LIC groups 201 to 203 (YES at Step S125), the charge-discharge managing unit 105 connects charge-discharge paths of the two of the LIC groups 201 to 203 that have the priorities of 1 and 2, respectively (Step S126).

When it is difficult to make power supply by two of the LIC groups 201 to 203 (NO at Step S125), the charge-discharge managing unit 105 connects charge-discharge paths of all the LIC groups 201 to 203 (Step S127).

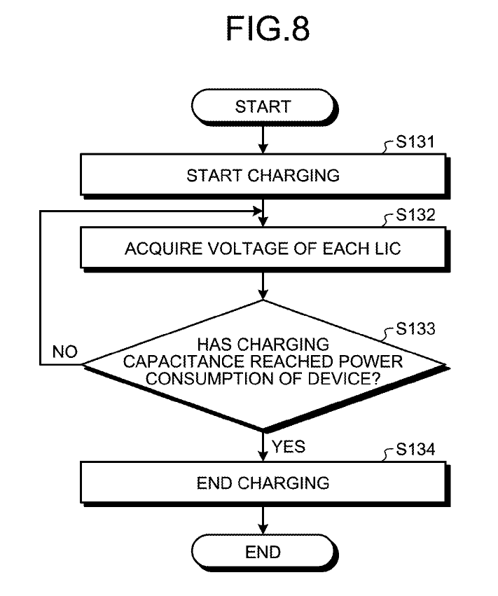

Next, a flow of a charge control process is described with reference to FIG. 8. FIG. 8 is a flowchart of an example of the charge control process. The flow illustrated in FIG. 8 is an example of the charge control process performed at Step S7 in FIG. 4.

The charge-discharge managing unit 105 causes the switching circuit 13 to start charging (Step S131).

The charge-discharge managing unit 105 acquires a voltage of each LIC that is a target of charging and discharging among the LICs 21 to 26 from the voltage monitoring unit 101 (Step S132).

Next, the charge-discharge managing unit 105 determines whether a charging capacitance has reached the power consumption of the device 2 (Step S133). When the charging capacitance has not reached the power consumption of the device 2 (NO at Step S133), the charge-discharge managing unit 105 returns to Step S132.

When the charging capacitance has reached the power consumption of the device 2 (YES at Step S133), the charge-discharge managing unit 105 causes the switching circuit 13 to stop charging (Step S134).

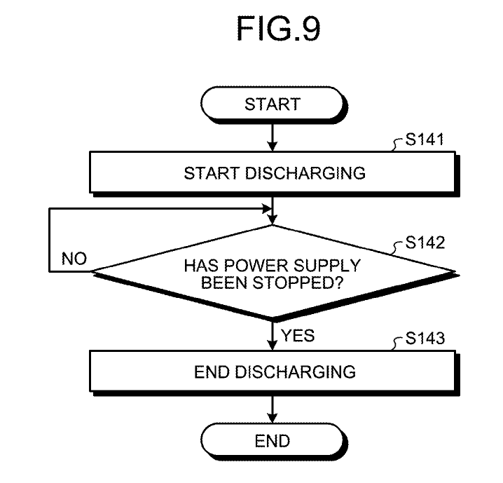

Next, a flow of a discharge control process is described with reference to FIG. 9. FIG. 9 is a flowchart of an example of the discharge control process. The flow illustrated in FIG. 9 is an example of the discharge control process performed at Step S11 in FIG. 4.

The charge-discharge managing unit 105 causes the switching circuit 13 to start discharging (Step S141).

Thereafter, the charge-discharge managing unit 105 detects recovery of power supply to the device 2 by the commercial power supply 3, from the power supply to the charging circuit 11, and determines whether to stop the power supply (Step S142). Where the power supply is not stopped (NO at Step S142), the charge-discharge managing unit 105 stands by until it is determined that the power supply is stopped.

On the other hand, when the power supply is stopped (YES at Step S142), the charge-discharge managing unit 105 causes the switching circuit 13 to end discharging (Step S143).

As described above, in the power supply apparatus according to the present embodiment, the number of LICs to be used is changed in accordance with power consumption. Further, an LIC having a longer life is used preferentially. Due to this configuration, an appropriate number of LICs for supplying the power consumption are used, and therefore it is possible to suppress useless charging and discharging and to achieve efficient charging and discharging of LICs. In addition, because an LIC having a longer life is preferentially used, use statuses of respective LICs mounted on an LIC-mounted module can be made uniform, and degradation of a specific LIC can be lessened. Accordingly, the life of the LIC-mounted module as a whole can be made longer.

Furthermore, because an LIC can be replaced with a new LIC in units of LIC group, it is possible to reduce replacement of an LIC of which the life has not been expired yet. Therefore, the life of the LIC-mounted module as a whole can be made longer.

(Modification)

In the present embodiment, while an LIC-mounted module in which two rows of three serially connected LICs are arranged has been described, the arrangement of LICs is not limited thereto. For example, three or more LICs can be arranged in parallel. In this case, all of the LICs arranged in parallel can be handled as one LIC group, or these LICs in parallel are handled by being divided into a plurality of LIC groups. Further, when the LICs are divided into LIC groups, as far as these are LICs arranged in parallel, these LICs can be configured to be replaceable in each LIC group. In addition, LICs can be managed one by one individually. However, when LICs are managed by dividing them into a certain number of groups, a path structure such as switches can be simplified and management of the LICs can be facilitated.

According to an aspect of the power supply apparatus and the charge-discharge control method disclosed in the present application, there is an effect where the life of LIC-mounted modules can be made longer.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A power supply apparatus comprising:
a plurality of power storage devices that are grouped into a plurality of sets;
a switching unit that switches a power-feed path to allow charging and discharging to be performed for a combination of the sets;
a life diagnostic unit that obtains lives of the power storage devices;
a priority setting unit that sets a priority of each of the sets based on the lives of the respective power storage devices; and
a charge-discharge managing unit that selects one or more of the sets for which charging and discharging are performed, based on the priority set by the priority setting unit and supplied power demanded during discharging, and that controls the switching unit to allow charging and discharging to be performed for a combination of selected one or more of the sets.

2. The power supply apparatus according to claim 1, wherein
the priority setting unit obtains a group life of each of the sets in accordance with the lives of the power storage devices, and
the charge-discharge managing unit determines the priority in such a manner that the priority is lower as the group life is shorter, and selects one or more of the sets for which charging and discharging are performed in descending order of the priority.

3. The power supply apparatus according to claim 1, wherein the priority setting unit acquires the supplied power demanded during discharging from a device that is a discharge destination, and selects such number of the sets that charging and discharging are performed to achieve a charging capacitance equal to or larger than the acquired supplied power.

4. The power supply apparatus according to claim 1, wherein each of the sets is formed by every group of the storage devices arranged in parallel, and the sets are connected in series.

5. The power supply apparatus according to claim 1, wherein the storage devices are replaceable in each of the sets.

6. A charge-discharge control method of a power supply apparatus including a plurality of power storage devices grouped into a plurality of sets and a switch that switches a power-feed path to allow charging and discharging to be performed for a combination of the sets, the method comprising:
obtaining lives of the power storage devices;
setting a priority of each of the sets based on the lives of the power storage devices;
selecting one or more of the sets for which charging and discharging are performed, based on the set priority and supplied power demanded during discharging; and
controlling the switch to allow charging and discharging to be performed for a combination of the selected one or more of the sets.
